(19) United States
(12) Patent Application Publication
(10) Pub. No.: US 2026/0020558 A1
(43) Pub. Date: Jan. 22, 2026

(54) NEW AGROCHEMICAL FORMULATIONS

(71) Applicant: BASF SE, Ludwigshafen am Rhein (DE)

(72) Inventors: Christian SOWA, Limburgerhof (DE); Reiner WEILER, Limburgerhof (DE); Markus FIESS, Limburderhof (DE)

(21) Appl. No.: 18/993,836

(22) PCT Filed: Jul. 3, 2023
(86) PCT No.: PCT/EP2023/068228

§ 371 Date: Jan. 13, 2025

(30) Foreign Application Priority Data
Jul. 13, 2022 (EP) 22184761.9

(51) Int. Cl. A01N 25/02; A01N 43/56; A01N 43/653; A01N 43/713; A01P 3/00; A01P 7/02; A01P 7/04; A01P 13/00; A01P 21/00

(52) U.S. Cl. CPC A01N 25/02; A01N 43/56; A01N 43/653; A01N 43/713; A01P 3/00; A01P 7/02; A01P 7/04; A01P 13/00; A01P 21/00

(57) ABSTRACT

Liquid formulation comprising
A. one or more pesticide P,
B. a solvent system S comprising an ester of benzoic acid,
C. optionally at least one anionic and/or nonionic surfactant;
D. Optionally further formulation auxiliaries;
   wherein said one or more pesticide P is completely dissolved in solvent system S at 20° C.

The present invention is directed to liquid agrochemical formulations comprising
A. one or more pesticide P,
B. a solvent system S comprising an ester of benzoic acid,
C. optionally at least one anionic and/or nonionic surfactant
D. Optionally further formulation auxiliaries;
   wherein said one or more pesticide P is completely dissolved in solvent system S at 20° C.

There is a continued need for improving the efficiency and stability of agrochemical formulations. Many pesticides are known to have a low solubility in most solvents, leading to challenges for providing stable and efficient formulations of such fungicides.

The objective of the present invention was therefore to prove a stable and biologically effective formulation of pesticides. This objective has been achieved by liquid agrochemical formulations comprising
A. one or more pesticide P,
B. a solvent system S comprising an ester of benzoic acid,
C. optionally at least one anionic and/or nonionic surfactant
D. Optionally further formulation auxiliaries;
   wherein said one or more pesticide P is completely dissolved in solvent system S at 20° C.

Herein, the terms “compositions” and “formulations” are used synonymously.

When reference is made herein to a state of aggregation (e.g. “solid state”) or to other physical parameters like solubilities, this shall be, unless stated otherwise, at a temperature of 20° C.

Compositions of the invention comprise at least one pesticide P.

The term pesticides refers to at least one active substance selected from the group of the fungicides, insecticides, nematicides, herbicides, safeners and/or growth regulators.

Pesticide P can in principle be any kind of pesticide that is soluble in solvent system S.

Preferred pesticides P are fungicides, insecticides, herbicides and growth regulators. In one embodiment, pesticides P are insecticides. In one embodiment, pesticides P are fungicides. In one embodiment, pesticides P are herbicides. Mixtures of pesticides from two or more of the abovementioned classes may also be used. The skilled worker is familiar with such pesticides, which can be found, for example, in Pesticide Manual, 15th Ed. (2009), The British Crop Protection Council, London.

Suitable insecticides include insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, METI acarizides, and insecticides such as chloropicrin, pymetrozin, flonicamid, clofentezin, hexythiazox, etoxazole, diafenthiuron, propargite, tetradifon, chlorofenapyr, DNOC, buprofezine, cyromazine, amitraz, hydramethylnon, acequinocyl, fluacrypyrim, rotenone, or their derivatives. Suitable fungicides include fungicides from the classes of dinitroanilines, allylamines, strobilurines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides include herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl (thio) benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The composition may comprise one or more pesticides.

The following pesticides are suitable, by way of example (pesticides A) to K) are fungicides):
A) Respiration inhibitors
   complex-III-inhibitors at the Qo-site (for example strobilurins): azoxystrobin, coumethoxystrobin, coumoxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, methyl 2-[2-(2,5-dimethylphenyloxymethyl)phenyl]-3-methoxyacrylate, 2-(2-(3-(2,6-dichlorophenyl)-1-methylallylideneaminooxymethyl)phenyl)-2-methoxyimino-N-methylacetamide, pyribencarb, triclopyricarb/chlorodincarb, famoxadon, fenamidon, metyltetraprole;
   complex-III-inhibitors at the Q-site: cyazofamid, amisulbrom;
   complex-II-inhibitors (for example carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide and N-[9-(dichloromethylene)-1,2,3,4-tetrahydro-1,4-methanonaphthalen-5-yl]-3-(difluoromethyl)-1-methyl-1H-pyrazole-4-carboxamide;
   other respiration inhibitors (for example complex, decouplers): diflumetorim; nitrophenyl derivatives: binapacryl, dinobuton, dinocap, fluazinam; ferimzone; organometal compounds: fentin salts such as fentin acetate, fentin chloride or fentine hydroxide; ametoctradin; and silthiofam;
B) Sterol biosynthesis inhibitors (SBI fungicides)
   C14-demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizole; pyrimidines, pyridines and piperazines: fenarimol, nuarimol, pyrifenox, triforine;
   delta14-reductase inhibitors: aldimorph, dodemorph, dodemorph acetate, fenpropimorph, tridemorph, fenpropidin, piperalin, spiroxamine;
   3-ketoreductase inhibitors: fenhexamid;
C) Nucleic acid synthesis inhibitors
   phenylamides or acylamino acid fungicides: benalaxyl, benalaxyl-m, kiralaxyl, metalaxyl, metalaxyl-M (mefenoxam), ofurace, oxadixyl;
   others: hymexazole, octhilinone, oxolinic acid, bupirimate;
D) Cell division and cytoskeleton inhibitors
   tubulin inhibitors such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine;
   further cell division inhibitors: diethofencarb, ethaboxam, pencycuron, fluopicolid, zoxamid, metrafenon, pyriofenon;
E) Amino acid synthesis and protein synthesis inhibitors
   methionine synthesis inhibitors (anilinopyrimidines): cyprodinil, mepanipyrim, pyrimethanil;
   protein synthesis inhibitors: blasticidin-S, kasugamycin, kasugamycin hydrochloride hydrate, mildiomycin, streptomycin, oxytetracyclin, polyoxin, validamycin A;
F) Signal transduction inhibitors
   MAP/histidine kinase inhibitors: fluoroimide, iprodione, procymidone, vinclozolin, fenpiclonil, fludioxonil;
   G-protein inhibitors: quinoxyfen;
G) Lipid and membrane synthesis inhibitors
   phospholipid biosynthesis inhibitors: edifenphos, iprobenfos, pyrazophos, isoprothiolane;
   lipid peroxidation: dicloran, quintozene, tecnazene, tolclofos-methyl, biphenyl, chloroneb, etridiazole;
   phospholipid biosynthesis and cell wall attachment: dimethomorph, flumorph, mandipropamid, pyrimorph, benthiavalicarb, iprovalicarb, valifenalate and 4-fluorophenyl N-(1-(1-(4-cyanophenyl) ethanesulfonyl) but-2-yl) carbamate;
   compounds which affect cell membrane permeability and fatty acids: propamocarb, propamocarb hydrochloride
H) “Multi-site” inhibitors
   inorganic active substances: Bordeaux mixture, copper acetate, copper hydroxide, copper oxychloride, basic copper sulfate, sulfur;
   thio- and dithiocarbamates: ferbam, mancozeb, maneb, metam, metiram, propineb, thiram, zineb, ziram;
   organochlorine compounds (for example phthalimides, sulfamides, chloronitriles): anilazine, chlorothalonil, captafol, captan, folpet, dichlofluanid, dichlorophen, flusulfamide, hexachlorobenzene, pentachlorophenol and its salts, phthalid, tolylfluanid, N-(4-chloro-2-nitrophenyl)-N-ethyl-4-methylbenzenesulfonamide;
   guanidines and others: guanidine, dodine, dodine-free base, guazatin, guazatin acetate, iminoctadin, iminoctadin triacetate, iminoctadin tris (albesilate), dithianon;
I) Cell wall biosynthesis inhibitors
   glucan synthesis inhibitors: validamycin, polyoxin B; melanin synthesis inhibitors: pyroquilon, tricyclazole, carpropamid, dicyclomet, fenoxanil;
J) Resistance inductors
   acibenzolar-S-methyl, probenazol, isotianil, tiadinil, prohexadione-calcium; phosphonates: fosetyl, fosetyl-aluminum, phosphorous acid and its salts;
K) Unknown mode of action
   bronopol, quinomethionate, cyflufenamid, cymoxanil, dazomet, debacarb, diclomezin, difenzoquat, difenzoquat-methyl sulfate, diphenylamine, fenpyrazamine, flumetover, flusulfamid, flutianil, methasulfocarb, nitrapyrin, nitrothal-isopropyl, oxine-copper, proquinazid, tebufloquin, tecloftalam, triazoxide, 2-butoxy-6-iodo-3-propylchromene-4-one, N(cyclopropylmethoxyimino-(6-difluoromethoxy-2,3-difluorophenyl)methyl)-2-phenylacetamide, N′-(4-(4-chloro-3-trifluoromethylphenoxy)-2,5-dimethylphenyl)-N-ethyl-Nmethylformamidine, N′-(4-(4-fluoro-3-trifluoromethylphenoxy)-2,5-dimethylphenyl)-N-ethyl-Nmethylformamidine, N′-(2-methyl-5-trifluoromethyl-4-(3-trimethylsilanylpropoxy)phenyl)-Nethyl-N-methylformamidine, N′-(5-difluoromethyl-2-methyl-4-(3-trimethylsilanylpropoxy)phenyl)-N-ethyl-N-methylformamidine, N-methyl-(1,2,3,4-tetrahydronaphthalen-1-yl)-2-{1-[2-(5-methyl-3-trifluoromethylpyrazol-1-yl) acetyl]piperidin-4-yl} thiazole-4-carboxamide, Nmethyl-(R)-1,2,3,4-tetrahydronaphthalen-1-yl 2-{1-[2-(5-methyl-3-trifluoromethylpyrazol-1-yl)acetyl]piperidin-4-yl} thiazole-4-carboxamide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yllethanone, 6-tert.-butyl-8-fluoro-2,3-dimethylquinolin-4-yl methoxyacetate, N-methyl-2-{1-[(5-methyl-3-trifluoromethyl-1H-pyrazol-1-yl) acetyl]piperidin-4-yl}-N-[(1R)-1,2,3,4-tetrahydronaphthalen-1-yl]-4-thiazolecarboxamide, 3-[5-(4-methylphenyl)-2,3-dimethylisoxazolidin-3-yl]-pyridine, 3-[5-(4-chlorophenyl)-2,3-dimethylisoxazolidin-3-yl]-pyridine (pyrisoxazol), N-(6-methoxypyridin-3-yl) cyclopropanecarboxamide, 5-chloro-1-(4,6-dimethoxypyrimidin-2-yl)-2-methyl-1H-benzoimidazole, 2-(4-chlorophenyl)-N-[4-(3,4-dimethoxyphenyl) isoxazol-5-yl]-2-prop-2-ynyloxyacetamide;
M) Growth regulators
   abscisic acid, amidochlor, ancymidole, 6-benzylaminopurine, brassinolide, butralin, chlormequat (chlormequat chloride), choline chloride, cyclanilid, daminozide, dikegulac, dimethipin, 2,6-dimethylpuridine, ethephon, flumetralin, flurprimidol, fluthiacet, forchlorfenuron, gibberellic acid, inabenfid, indole-3-acetic acid, maleic hydrazide, mefluidid, mepiquat (mepiquat chloride), metconazole, naphthaleneacetic acid, N-6-benzyladenine, paclobutrazole, prohexadione (prohexadione-calcium), prohydrojasmone, thidiazuron, triapenthenol, tributylphosphorotrithioate, 2,3,5-triiodobenzoic acid, trinexapac-ethyl and uniconazole;
N) Herbicides
   acetamides: acetochlor, alachlor, butachlor, dimethachlor, dimethenamid, flufenacet, mefenacet, metolachlor, metazachlor, napropamid, naproanilid, pethoxamid, pretilachlor, propachlor, thenylchlor;
   amino acid analogs: bilanafos, glyphosate, glufosinate, sulfosate;
   aryloxyphenoxypropionates: clodinafop, cyhalofop-butyl, fenoxaprop, fluazifop, haloxyfop, metamifop, propaquizafop, quizalofop, quizalofop-P-tefuryl;
   bipyridyls: diquat, paraquat;
   carbamates and thiocarbamates: asulam, butylate, carbetamide, desmedipham, dimepiperat, eptam (EPTC), esprocarb, molinate, orbencarb, phenmedipham, prosulfocarb, pyributicarb, thiobencarb, triallate;
   cyclohexanediones: butroxydim, clethodim, cycloxydim, profoxydim, sethoxydim, tepraloxydim, tralkoxydim;
   dinitroanilines: benfluralin, ethalfluralin, oryzalin, pendimethalin, prodiamine, trifluralin;
   diphenyl ethers: acifluorfen, aclonifen, bifenox, diclofop, ethoxyfen, fomesafen, lactofen, oxyfluorfen;
   hydroxybenzonitriles: bromoxynil, dichlobenil, ioxynil;
   imidazolinones: imazamethabenz, imazamox, imazapic, imazapyr, imazaquin, imazethapyr;
   phenoxyacetic acids: clomeprop, 2,4-dichlorophenoxyacetic acid (2,4-D), 2,4-DB, dichlorprop, MCPA, MCPA-thioethyl, MCPB, mecoprop;
   pyrazines: chloridazon, flufenpyr-ethyl, fluthiacet, norflurazon, pyridate;
   pyridines: aminopyralid, clopyralid, diflufenican, dithiopyr, fluridone, fluroxypyr, picloram, picolinafen, thiazopyr;
   sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl) sulfonyl)-3-(4,6-dimethoxypyrimidin-2-yl) urea;
   triazines: ametryne, atrazine, cyanazine, dimethametryne, ethiozine, hexazinone, metamitron, metribuzine, prometryne, simazine, terbuthylazine, terbutryne, triaziflam;
   ureas: chlortoluron, daimuron, diuron, fluometuron, isoproturon, linuron, methabenzthiazuron, tebuthiuron;
   other acetolactate synthase inhibitors: bispyribac-sodium, cloransulam-methyl, diclosulam, florasulam, flucarbazone, flumetsulam, metosulam, orthosulfamuron, penoxsulam, propoxycarbazone, pyribambenz-propyl, pyribenzoxim, pyriftalide, pyriminobac-methyl, pyrimisulfan, pyrithiobac, pyroxasulfon, pyroxsulam;
   others: amicarbazone, aminotriazole, anilofos, beflubutamid, benazolin, bencarbazone, benfluresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamid, dicamba, difenzoquat, diflufenzopyr, Drechslera monoceras, endothal, ethofumesate, etobenzanid, fentrazamide, flumiclorac-pentyl, flumioxazin, flupoxam, fluorochloridon, flurtamon, indanofan, isoxaben, isoxaflutol, lenacil, propanil, propyzamide, quinclorac, quinmerac, mesotrione, methylarsenic acid, naptalam, oxadiargyl, oxadiazone, oxaziclomefon, pentoxazone, pinoxaden, pyraclonil, pyraflufen-ethyl, pyrasulfotol, pyrazoxyfen, pyrazolynate, quinoclamin, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridin-3-carbonyl] bicyclo[3.2.1]oct-3-en-2-one, ethyl (3-[2-chloro-4-fluoro-5-(3-methyl-2,6-dioxo-4-trifluoromethyl-3,6-dihydro-2H-pyrimidin-1-yl) phenoxy] pyridin-2-yloxy) acetate, methyl 6-amino-5-chloro-2-cyclopropylpyrimidine-4-carboxylate, 6-chloro-3-(2-cyclopropyl-6-methylphenoxy) pyridazin-4-ol, 4-amino-3-chloro-6-(4-chlorophenyl)-5-fluoropyridin-2-carboxylic acid, methyl 4-amino-3-chloro-6-(4-chloro-2-fluoro-3-methoxyphenyl)pyridin-2-carboxylate and methyl 4-amino-3-chloro-6-(4-chloro-3-dimethylamino-2-fluorophenyl)pyridin-2-carboxylate;
O) Insecticides
   organo (thio) phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
   carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
   pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin, profluthrin, dimefluthrin,
   insect growth inhibitors: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazin; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
   nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl[1,3,5]triazinane;
   GABA antagonists: endosulfan, ethiprole, fipronil, vaniliprole, pyrafluprole, pyriprole, N-5-amino-1-(2,6-dichloro-4-methylphenyl)-4-sulfinamoyl-1H-pyrazole-3-thiocarboxamide;
   macrocyclic lactones: abamectin, emamectin, milbemectin, lepimectin, spinosad, spinetoram;
   mitochondrial electron transport chain inhibitor (METI) I acaricides: fenazaquin, pyridaben, tebufenpyrad, tolfenpyrad, flufenerim;
   METI II and III substances: acequinocyl, fluacyprim, hydramethylnone;
   decouplers: chlorfenapyr;
   inhibitors of oxidative phosphorylation: cyhexatin, diafenthiuron, fenbutatin oxide, propargite;
   insect ecdysis inhibitors: cryomazine;
   ‘mixed function oxidase’ inhibitors: piperonyl butoxide;
   sodium channel blockers: indoxacarb, metaflumizone;
   others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluron and pyrifluquinazone.

In one embodiment, pesticide P is water insoluble.

The term “water insoluble” as used herein means that a component has a solubility in water at 20° C. and at neutral pH of 10 g/l or less, preferably 1 g/l or less or of 0.1 g/l or less or of 0.01 g/l or less.

In one embodiment, pesticide P comprises metyltetraprole, mefentrifluconazole, fluxapyroxad, Inpyrfluxam, Kresoxim methyl, Pyraclostrobin, Fluopyram, saflufenacil, broflanilide, dimpropyridaz, fenmezoditiaz, Cinnamaldehyde, Prothioconazole, Trifloxystrobin, Fluxapyroxad, Sprioxamin, afidopyropen, alpha-cypermethrin, fipronil, cyflumetofen, boscalid, epoxiconazole, metconazole, metrafenone, prothioconazole, bentazone, dimethenamide, tembotrione, trifludimoxazin, Mefenpyr-Diethyl, azoxystrobin, picoxystrobin, fluoxastrobin, oryzastrobin, dimoxystrobin, indiflin or mixtures thereof.Preferably, pesticide P comprises metyltetraprole, mefentrifluconazole, fluxapyroxad, Inpyrfluxam, Kresoxim methyl, Pyraclostrobin, Fluopyram, saflufenacil, broflanilide, dimpropyridaz, fenmezoditiaz, Cinnamaldehyde, Prothioconazole, Trifloxystrobin, Fluxapyroxad, Sprioxamin, afidopyropen, alpha-cypermethrin, fipronil, cyflumetofen, boscalid, epoxiconazole, metconazole, metrafenone, prothioconazole, bentazone, dimethenamide, tembotrione, trifludimoxazin, Mefenpyr-Diethyl or mixtures thereof.

More preferably, pesticide P comprises metyltetraprole, mefentrifluconazol, fluxapyroxad, Inpyrfluxam, Kresoxim methyl, Pyraclostrobin, Fluopyram, Cinnamaldehyde, Prothioconazole, Trifloxystrobin, Fluxapyroxad, Sprioxamin, Mefenpyr-Diethyl or mixtures thereof.

More preferably, pesticide P comprises metyltetraprole, mefentrifluconazol, fluxapyroxad, Inpyrfluxam, Kresoxim methyl, Pyraclostrobin, Fluopyram, Cinnamaldehyde, Prothioconazole, Trifloxystrobin, Fluxapyroxad, Sprioxamin, Mefenpyr-Diethyl, indiflin or mixtures thereof

In one embodiment, pesticide P comprises a strobilurin pesticide. Examples of strobilurin pesticides include azoxystrobin, kresoxim methyl, picoxystrobin, fluoxastrobin, oryzastrobin, dimoxystrobin, pyraclostrobin, trifloxystrobin and metyltetraprole.

In one embodiment, pesticide P comprises indiflin, metyltetraprole, mefentrifluconazol, fluxapyroxad or mixtures thereof.

In one embodiment, pesticide P comprises indiflin, mefentrifluconazol, fluxapyroxad, a strobilurin pesticide or mixtures thereof.

According to the invention, pesticide P is completely dissolved in solvent system S at 20° C., where said solvent system S comprises an ester of benzoic acid.

In one embodiment, said ester of benzoic acid is selected from esters with monools or diols.

In one embodiment, said ester of benzoic acid is selected from alkyl benzoate, especially methyl benzoate, and aralkyl benzoate, especially benzyl benzoate.

In one embodiment, said ester of benzoic acid is selected from alkyl benzoate.

In one embodiment, said ester of benzoic acid is selected from methyl benzoate and benzyl benzoate.

In one embodiment, said ester of benzoic acid is benzyl benzoate.

In one embodiment said ester of benzoic acid is methyl benzoate.

In one embodiment, said ester of benzoic acid is an ester with a glycol or diglycol.

In one embodiment, said ester of benzoic acid is a diester with a glycol or diglycol, in each case comprising two benzoic acid moieties. In one embodiment, said ester of benzoic acid is a diester comprising two benzoic acid moieties esterified with a diol selected from ethylene glycol, diethylene glycol, propylene glycol or dipropylene glycol.

In one embodiment, said ester of benzoic acid is diethylene glycol dibenzoate.

In one embodiment, said ester of benzoic acid is ethylene glycol dibenzoate.

In one embodiment, said ester of benzoic acid is dipropylene glycol dibenzoate.

In one embodiment, said ester of benzoic acid is propylene glycol dibenzoate.

Typically, solvent system S comprises 5 to 75 wt % of benzoic acid ester, preferably 10 to 70 wt %, more preferably 30 to 65 wt %, in each case based on solvent system S.

In one embodiment, solvent system S comprises 5 to 75 wt % of methyl benzoate, preferably 10 to 70 wt %, more preferably 30 to 65 wt % in each case based on solvent system S.

In one embodiment, solvent system S comprises 5 to 75 wt % of benzyl benzoate, preferably 10 to 70 wt %, more preferably 30 to 65 wt %, in each case based on solvent system S.

In one embodiment, solvent system S comprises 5 to 75 wt % of a diester of benzoic acid with a glycol or diglycol, preferably 10 to 70 wt %, more preferably 30 to 65 wt %, in each case based on solvent system S.

In one embodiment, solvent system S comprises 5 to 75 wt % of diethylene glycol dibenzoate, preferably 10 to 70 wt %, more preferably 30 to 65 wt %, in each case based on solvent system S.

In one embodiment, solvent system S comprises 5 to 75 wt % of ethylene glycol dibenzoate, preferably 10 to 70 wt %, more preferably 30 to 65 wt %, in each case based on solvent system

S.

In one embodiment, solvent system S comprises 5 to 75 wt % of dipropylene glycol dibenzoate, preferably 10 to 70 wt %, more preferably 30 to 65 wt %, in each case based on solvent system S.

In one embodiment, solvent system S comprises 5 to 75 wt % of propylene glycol dibenzoate, preferably 10 to 70 wt %, more preferably 30 to 65 wt %, in each case based on solvent system S.

In one embodiment, solvent system S comprises at least one further solvent.

In one embodiment, solvent system S comprises at least one further solvent that is selected from aromatic hydrocarbons, N-alkyl pyrrolidone (especially N-methyl pyrrolidone, N-(n-butyl) pyrrolidone, N-(t-butyl) pyrrolidone or N-(sek-butyl) pyrrolidone), dibutyl adipate, dimethyl adipate, dimethylsulfoxide, N, N-dialkyl lactamide (especially N,N-dimethyllactamide), N, N-dialkyl amide (especially N,N-dimethyl octanoic acid amide, N,N-dimethyl decanoic acid amide, N,N-dimethyl capric amide, N,N-dimethyl caprylic amide), propylene carbonate, gamma butyrolactone or 1,3 dimethyl-2-imidazolidinone.

In one embodiment, solvent system S comprises at least one further solvent that is selected from aromatic hydrocarbons, N-methyl pyrrolidone, N-(n-butyl) pyrrolidone, N-(t-butyl) pyrrolidone or N-(sek-butyl) pyrrolidone, dibutyl adipate, dimethyl adipate, dimethylsulfoxide, N,N-dimethyllactamide, N,N-dimethyl octanoic acid amide, N,N-dimethyl decanoic acid amide, N,N-dimethyl capric amide, N,N-dimethyl caprylic amide, propylene carbonate, gamma butyrolactone or 1,3 dimethyl-2-imidazolidinone.

In one embodiment, solvent system S comprises at least one further solvent that is selected from N-alkyl pyrrolidone (especially N-methyl pyrrolidone, N-(n-butyl) pyrrolidone, N-(t-butyl) pyrrolidone or N-(sek-butyl) pyrrolidone), dibutyl adipate, dimethyl adipate, dimethylsulfoxide, N,N-dialkyl lactamide (especially N,N-dimethyllactamide), N,N-dialkyl amide (especially N,N-dimethyl octanoic acid amide, N, N-dimethyl decanoic acid amide, N,N-dimethyl capric amide, N,N-dimethyl caprylic amide), propylene carbonate, gamma butyrolactone or 1,3 dimethyl-2-imidazolidinone.

In one embodiment, solvent system S comprises at least one further solvent that is selected from N-methyl pyrrolidone, N-(n-butyl) pyrrolidone, N-(t-butyl) pyrrolidone or N-(sek-butyl) pyrrolidone, dibutyl adipate, dimethyl adipate, dimethylsulfoxide, N,N-dimethyllactamide, N,N-dimethyl octanoic acid amide, N,N-dimethyl decanoic acid amide, N,N-dimethyl capric amide, N,N-dimethyl caprylic amide, propylene carbonate, gamma butyrolactone or 1,3 dimethyl-2-imidazolidinone.

In one embodiment, solvent system S comprises at least one aromatic hydrocarbon.

In one embodiment, solvent system S comprises at least one aromatic hydrocarbon and at least one water miscible solvent.

In one embodiment, solvent system S comprises at least one aromatic hydrocarbon and at least one solvent selected from N-alkyl pyrrolidone (especially N-methyl pyrrolidone, N-(n-butyl) pyrrolidone, N-(t-butyl) pyrrolidone or N-(sek-butyl) pyrrolidone), dibutyl adipate, dimethyl adipate, dimethylsulfoxide, N, N-dialkyl lactamide, especially N, N-dimethyllactamide, N, N-dialkyl amide (especially N,N-dimethyl octanoic acid amide, N,N-dimethyl decanoic acid amide, N,N-dimethyl capric amide, N,N-dimethyl caprylic amide), propylene carbonate, gamma butyrolactone or 1,3 dimethyl-2-imidazolidinone.

In one embodiment, solvent system S comprises at least one aromatic hydrocarbon and at least one solvent selected from N-methyl pyrrolidone, N-(n-butyl) pyrrolidone, N-(t-butyl) pyrrolidone or N-(sek-butyl) pyrrolidone, dibutyl adipate, dimethyl adipate, dimethylsulfoxide, N,N-dimethyllactamide, N,N-dimethyl octanoic acid amide, N,N-dimethyl decanoic acid amide, N,N-dimethyl capric amide, N,N-dimethyl caprylic amide, propylene carbonate, gamma butyrolactone or 1,3 dimethyl-2-imidazolidinone.

In one embodiment, pesticide P comprises indiflin, mefentrifluconazol, fluxapyroxad, a strobilurin pesticide or mixtures thereof and solvent system S comprises benzyl benzoate or propylene glycol dibenzoate or mixtures thereof.

In one embodiment, pesticide P comprises indiflin, mefentrifluconazol, fluxapyroxad, a strobilurin pesticide or mixtures thereof and solvent system S comprises benzyl benzoate.

In one embodiment, pesticide P comprises indiflin, mefentrifluconazol, fluxapyroxad, a strobilurin pesticide or mixtures thereof and solvent system S comprises propylene glycol dibenzoate.

In one embodiment, pesticide P comprises a strobilurin pesticide and solvent system S comprises benzyl benzoate or propylene glycol dibenzoate or mixtures thereof.

In one embodiment, pesticide P comprises a strobilurin pesticide and solvent system S comprises benzyl benzoate.

In one embodiment, pesticide P comprises a strobilurin pesticide and solvent system S comprises propylene glycol dibenzoate.

In one embodiment, pesticide P comprises indiflin, metyltetraprole, mefentrifluconazol, fluxapyroxad or mixtures thereof and solvent system S comprises benzyl benzoate or propylene glycol dibenzoate or mixtures thereof.

In one embodiment, pesticide P comprises indiflin, metyltetraprole, mefentrifluconazol, fluxapyroxad or mixtures thereof and solvent system S comprises benzyl benzoate.

In one embodiment, pesticide P comprises indiflin, metyltetraprole, mefentrifluconazol, fluxapyroxad or mixtures thereof and solvent system S comprises propylene glycol dibenzoate.

In one embodiment, formulations of the invention comprise one or more anionic and/or nonionic surfactant. Some surfactants can also act as adjuvants.

Such anionic and/or nonionic surfactant can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants include alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of polymeric surfactants are home- or copolymers of vinylpyrrolidone, vinylalcohols, or vinylacetate.

In one embodiment, formulations of the invention comprise at least one surfactant of the general formula (I)

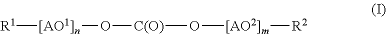

where
R¹ and R² are independently a C₆-C₃₂ hydrocarbon group,
AO¹ and AO² are independently a C₂-C₆ alkyleneoxy group, and
n and m are independently a value from 2 to 100.

In one embodiment the surfactant is of the formula (I) where R¹ and R² are independently a linear or branched, saturated or unsaturated C₈-C₂₀ alkyl, AO¹ and AO² are ethyleneoxy, and n and m are independently from 2.5 to 20.

In one embodiment the surfactant is of the formula (I) where R¹ and R² are 2-propylheptyl, AO¹ and AO² are independently ethyleneoxy, or ethyleneoxy and propyleneoxy, and n and m are independently from 2 to 30.

In one embodiment the surfactant is of the formula (I) where R¹ and R² are independently linear C₁₂-C₁₈ alkyl, AO¹ and AO² are independently ethyleneoxy, or ethyleneoxy and propyleneoxy, and n and m are independently from 2 to 30.

In one embodiment the surfactant is of the formula (I) where R¹ and R² are independently branched C₁₃ alkyl, AO¹ and AO² are independently ethyleneoxy, or ethyleneoxy and propyleneoxy, and n and m are independently from 2 to 30.

In one embodiment the surfactant is of formula (I), AO¹ and AO² being ethyleneoxy, R¹ and R² being a linear or branched, saturated or unsaturated C₈-C₂₀ alkyl, and n and m are independently from 2.5 to 20

In one embodiment the surfactant is of formula (I), AO¹ and AO² being ethyleneoxy, R¹ and R² being a linear or branched, saturated or unsaturated C₈-C₂₀ alkyl, and n and m are independently from 3 to 10.

In one embodiment the surfactant is of formula (I), AO¹ and AO² being ethyleneoxy, R¹ and R² being a linear or branched, saturated or unsaturated C₈-C₂₀ alkyl, and n and m are independently from 3 to 10

In one embodiment the surfactant of formula (I), where AO¹ and AO² are ethyleneoxy. This form corresponds to the alkoxylate of formula (II)

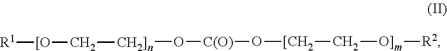

where R¹, R², n and m have the meanings and preferred forms as defined above.

In one embodiment the surfactant is of formula (II), R¹ and R² being a linear or branched, saturated or unsaturated C₁₂-C₁₈ alkyl, and n and m are independently from 4 to 9. In one embodiment the surfactant are compounds according to formula (II) wherein R¹ and R² are C₁₂-C₁₈ alkyl and n and m are 6 to 8.

In one embodiment the surfactant are compounds according to formula (II) wherein R¹ and R² are C₁₂-C₁₈ alkyl and n and m are 6.5 to 7.5.

In one embodiment, formulations of the invention comprise 2 to 15 wt % of at least one surfactant of formula (I) and 0 to 15 wt % of at least one anionic and/or nonionic surfactant different from surfactant C

In one embodiment, formulations of the invention comprise 2 to 15 wt % of at least one surfactant of formula (I) and 2 to 15 wt % of at least one anionic and/or nonionic surfactant different from surfactant C

In one embodiment, formulations of the invention comprise at least one surfactant of the general formula (the adjuvant is of the formula (III)

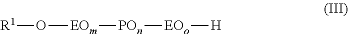

where
R1 is a C12-20 alkyl;
EO is ethyleneoxy;
PO is propyleneoxy;
m has a value from 1 to 20;
n has a value from 1 to 30; and
has a value from 1 to 10.

In one embodiment form R1 in formula (III) is a linear or branched C14-20 alkyl, the index m is from 2 to 15, the index n is from 5 to 30 and the index o is from 3 to 10.

In another embodiment R1 formula (III) is a linear C14-18 alkyl, the index m is from 3 to 15, the index n is from 9 to 25 and the index o is from 3 to 6.5.

In another embodiment R1 formula (III) is a linear or branched C16-18 alkyl, the index m is from 3 to 8, the index n is from 11 to 20 and the index o is from 3.5 to 5.5.

In one embodiment, formulations of the invention comprise at least one surfactant of the general formula (IV)

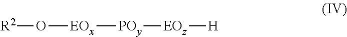

where
R2 is a C6-11 alkyl;
EO is ethyleneoxy;
PO is propyleneoxy;
x has a value from 1 to 20;
y has a value from 1 to 30; and
Z has a value from 0 to 10.
R2 in formula (IV) is usually a linear or branched (preferably branched) monovalent C6-11 aliphatic hydrocarbon group, or a mixture thereof, preferably a linear or branched C8-10 aliphatic hydrocarbon group. More preferably, R2 is a linear or branched, saturated or unsaturated C8-10 aliphatic hydrocarbon group, especially preferred linear or branched C10 alkyl, or a mixture thereof. Typical examples for R2 are linear or branched (preferably branched) hexyl, heptyl, octyl, nonyl, decyl and undecyl, or a mixture of the aforementioned residues. In another form, typical examples for R2 are linear or branched (preferably branched) octyl, nonyl and decyl, or a mixture of the aforementioned residues. In another form, R2 is linear or branched decyl, or a mixture of the aforementioned residues. In particular, R2 is 2-propylheptyl.

In a preferred form in formula (IV)
R2 is a linear or branched (preferably branched) hexyl, heptyl, octyl, nonyl, decyl and undecyl, or a mixture of the aforementioned residues;
x has a value from 1 to 20;
y has a value from 1 to 30; and
Z has a value from 1 to 10.

In another preferred form in formula (IV)
R2 is a linear or branched (preferably branched) hexyl, heptyl, octyl, nonyl, decyl and undecyl, or a mixture of the aforementioned residues;
x has a value from 3 to 15;
y has a value from 2 to 10; and
Z has a value from 1.5 to 8.

In another preferred form in formula (IV)
R2 is a linear or branched (preferably branched) hexyl, heptyl, octyl, nonyl, decyl and undecyl, or a mixture of the aforementioned residues;
x has a value from 4 to 8;
y has a value from 3 to 6; and
Z has a value from 2 to 4.

In another preferred form in formula (IV)
R2 is a branched hexyl, heptyl, octyl, nonyl, decyl and undecyl, or a mixture of the aforementioned residues;
x has a value from 5 to 6;
y has a value from 4 to 5; and
Z has a value from 2 to 3.

In another form in formula (IV)
R2 is a C8-11 alkyl;
x has a value from 2 to 15;
y has a value from 2 to 15; and
Z has a value of 0.

In another form in formula (IV)
R2 is a C9-11 alkyl;
x has a value from 3 to 10;
y has a value from 3 to 10; and
Z has a value of 0.

In one embodiment, formulations of the invention comprise at least one surfactant that is a polyalkylene oxide block copolymer.

In one embodiment, formulations of the invention comprise at least one surfactant that is a block polymer surfactant. The block polymer surfactant may be a diblock polymer or a triblock polymer, wherein the triblock polymer is preferred. The blocks of the block polymer surfactant may be of the A-B or A-B-A type, where the A-B-A type is preferred. Typically, the block polymers surfactant is a nonionic surfactant.

In one embodiment, formulations of the invention comprise at least one surfactant that is an alkoxylate block polymer, which may comprise blocks of polyethylene oxide and polypropylene oxide. The alkoxylate block polymers comprise usually at least 20 wt %, preferably at least 30 wt % of polymerized ethylene oxide. In a preferred form the alkoxylate block polymers comprise at least 10 wt %, preferably at least 15 wt % of polymerized ethylene oxide. The alkoxylate block polymers is preferably a block polymers A-B-A type comprising blocks of polyethylene oxide (block “A”) and polypropylene oxide (block “B”). The alkoxylate block polymers are in one embodiment terminated on both ends by hydroxyl groups. In one embodiment, the alkoxylate block polymers terminated on both ends by alkyl groups like methyl, ethyl or butyl. In one embodiment, the alkoxylate block polymers terminated on both ends by n-butyl groups. In one embodiment, the alkoxylate block polymers terminated on one end a hydroxy group and on one end by alkyl groups like methyl, ethyl or butyl.

In one embodiment, the molecular weight of the block polymer surfactant (e.g. the alkoxylate block polymer) may be from 1000 to 30000 Da, preferably from 2000 to 15000 Da.

In one embodiment, the block polymer surfactant (e.g. the alkoxylate block polymer) may have a solubility in water at 20° C. of at least 3 wt %, preferably at least 5 wt %, and in particular at least 8 wt %.

In one embodiment, the block polymer surfactant (e.g. the alkoxylate block polymer) may have a HLB value in the range from 8 to 22, preferably from 10 to 20. In another form the block polymer surfactant (e.g. the alkoxylate block polymer) may have a HLB value in the range from 1 to 10, preferably from 1 to 8. The HLB may be calculated by known methods.

In one embodiment, the block polymer surfactant is an alkoxylate block polymer of the A-B-A type comprising blocks of polyethylene oxide (block “A”) and polypropylene oxide (block “B”), and wherein the alkoxylate block polymer is terminated on both ends by hydroxyl groups.

In one embodiment, the surfactant is an alkoxylated alcohol.

In one form the alkoxylate is a short chain alkoxylated alkanol, which is an alkoxylated alkanol of the formula I, in which Ra is straight-chain or branched alkyl with from 1 to 8, preferably from 2 to 6, and in particular 3 to 5 carbon atoms. In another form the alkoxylate is a short chain alkoxylated alkanol, which is an alkoxylated alkanol of the formula II, in which R^{b} is straight-chain or branched alkyl with from 1 to 8, preferably from 2 to 6, and in particular 3 to 5 carbon atoms. The composition may comprise at least 0.1 wt %, at least 0.5 wt %, preferably at least 1 wt %, and in particular at least 1.5 wt % of the short chain alkoxylated alkanol. The composition may comprise from 0.1 to 20 wt %, preferably from 0.5 to 15 wt %, and in particular from 1 to 8 wt % of the short chain alkoxylated alkanol.

Typically, formulations of the invention comprise 0 to 30 wt %, preferably 1 to 20 wt %, more preferably 2 to 20 wt % and even more preferably 3 to 18 wt % of anionic and/or nonionic surfactants, in each case based on the formulation.

The aqueous compositions according to the invention may also comprise further customary formulation auxiliaries different from anionic or non-ionic surfactants. Examples of such further auxiliaries include such as viscosity-modifying additives (thickeners), antifoam agents, preservatives, buffers, inorganic dispersants, solid carriers or fillers, surfactants, dispersants, emulsifiers, wetters, adjuvants, solubilizers, penetration enhancers, protective colloids, adhesion agents, humectants, repellents, attractants, feeding stimulants, compatibilizers, bactericides, anti-freezing agents, anti-foaming agents, colorants, tackifiers and binders etc., which are usually employed in aqueous formulations active ingredients.

The amount of auxiliaries will typically not exceed 25 wt % or 10% by weight, in particular 5% by weight of the total weight of the formulation.

Antifoam agents suitable for the compositions according to the invention are, for example, silicone emulsions (such as, for example, Silicone SRE-PFL from Wacker or Rhodorsil® from Bluestar Silicones), polysiloxanes and modified polysiloxanes including polysiloxane blockpolymers such as FoamStar® SI and FoamStar® ST products of BASF SE, long-chain alcohols, fatty acids, organofluorine compounds and mixtures thereof.

The compositions of the invention may also contain one or more adjuvants different from anionic or nonionic surfactants. Suitable adjuvants are known to skilled persons and include surfactants, crop oil concentrates, spreader-stickers, wetting agents, and penetrants.

Suitable further surfactants are surface-active compounds, such as cationic, amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in Mccutcheon's, Vol. 1: Emulsifiers & Detergents, Mccutcheon's Directories, Glen Rock, USA, 2008 (International Ed. or North American Ed.).

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a neglectable or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable anti-freezing agents are ethylene glycol, propylene glycol, urea and glycerin.

Suitable anti-foaming agents are silicones, long chain alcohols, and salts of fatty acids.

Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

Suitable tackifiers or binders are polyvinylpyrrolidons, polyvinylacetates, polyvinyl alcohols, polyacrylates, biological or synthetic waxes, and cellulose ethers.

Typically, formulations of the invention comprise 0 to 10 wt %. preferably 0.1 to 10, more preferably 1 to 10 wt % of further formulation auxiliaries different from anionic and/or nonionic surfactants, in each case based on the formulation.

In one embodiment, formulations of the invention comprise, in each case based on the formulation,
A. 0.1 to 60 wt % of one or more pesticide P,
B. 5 to 75 wt % of a benzoic acid ester,
B1. 5 to 40 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 5 to 75 wt % of benzyl benzoate,
B1. 5 to 40 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 5 to 75 wt % of a methyl benzoate,
B1. 5 to 40 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 5 to 75 wt % of esters of benzoic acid with a glycol or diglycol, especially propylene glycol dibenzoate,
B1. 5 to 40 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 30 to 70 wt % of a benzoic acid ester,
B1. 10 to 30 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 30 to 70 wt % of benzyl benzoate,
B1. 10 to 30 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 30 to 70 wt % of a methyl benzoate,
B1. 10 to 30 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 60 wt % of one or more pesticide P,
B. 30 to 70 wt % of esters of benzoic acid with a glycol or diglycol, especially propylene glycol dibenzoate,
B1. 10 to 30 wt % of further solvents,
C. 1 to 30 wt % of at least one anionic and/or nonionic surfactant,
D. 0 to 20 wt % of further formulation auxiliaries.

In one embodiment, formulations of the invention comprise, in each case based on the formulation,
A. 0.1 to 20 wt % of one or more pesticide P,
B. 30 to 70 wt % of benzoic acid ester,
B1. 10 to 30 wt % of further solvents,
C. 2 to 20 wt % of at least one anionic and/or nonionic surfactant,
D. 0.1 to 10 wt % of further formulation auxiliaries.

In one embodiment, formulations of the invention comprise, in each case based on the formulation,
A. 0.1 to 20 wt % of one or more pesticide P,
B. 30 to 70 wt % of benzyl benzoate,
B1. 10 to 30 wt % of further solvents,
C. 2 to 20 wt % of at least one anionic and/or nonionic surfactant,
D. 0.1 to 10 wt % of further formulation auxiliaries.

In one embodiment, formulations of the invention comprise, in each case based on the formulation,
A. 0.1 to 20 wt % of one or more pesticide P,
B. 30 to 70 wt % of methyl benzoate,
B1. 10 to 30 wt % of further solvents,
C. 2 to 20 wt % of at least one anionic and/or nonionic surfactant,
D. 0.1 to 10 wt % of further formulation auxiliaries.

In one embodiment, formulations of the invention comprise, in each case based on the formulation,
A. 0.1 to 20 wt % of one or more pesticide P,
B. 30 to 70 wt % of esters of benzoic acid with a glycol or diglycol, especially propylene glycol dibenzoate,
B1. 10 to 30 wt % of further solvents,
C. 2 to 20 wt % of at least one anionic and/or nonionic surfactant,
D. 0.1 to 10 wt % of further formulation auxiliaries.

In one embodiment, formulations of the invention comprise, in each case based on the formulation,
A. 0.1 to 60 wt % of one or more pesticide P,
B. 40 to 70 wt % of benzoic acid ester,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P,
B. 40 to 70 wt % of benzyl benzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P,
B. 40 to 70 wt % of methyl benzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P,
B. 40 to 70 wt % of esters of benzoic acid with a glycol or diglycol, especially propylene glycol dibenzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulation according to the invention comprise
A. one or more pesticide P,
B. methylbenzoate
B1. optionally further solvents,
C. at least one surfactant of formula (I),
C1. at least one anionic and/or nonionic surfactant different from surfactant C,
D. optionally further formulation auxiliaries.

In one embodiment, formulation according to the invention comprise
A. Metyltetraprole,
B. methylbenzoate
B1. optionally further solvents,
C. at least one surfactant of formula (I),
C1. at least one anionic and/or nonionic surfactant different from surfactant C,
D. optionally further formulation auxiliaries.

In one embodiment, formulation according to the invention comprise
A. 0.1 to 10 wt % of Metyltetraprole,
B. 10 to 95 wt % of methylbenzoate
B1. 0 to 40 wt % of further solvents,
C. 2 to 20 wt % of at least one surfactant of formula (I),
C1. 0 to 10 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B1. 5 to 30 wt % of further solvents,
C. 2 to 15 wt % of at least one surfactant of formula (I),
C1. 2 to 15 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B1. 5 to 30 wt % of aromatic hydrocarbons such as Solvesso and water miscible solvents,
C. 2 to 15 wt % of at least one surfactant of formula (I),
C1. 5 to 15 wt % of at least one anionic and/or nonionic surfactant different from surfactant C,
D. 1 to 10 wt % of further formulation auxiliaries.

In one embodiment, formulation according to the invention comprise
A. 0.1 to 10 wt % of Metyltetraprole,
B. 40 to 70 wt % of Methylbenzoate,
B1. 5 to 15 wt % of a water immiscible solvent such as Solvesso and 5 to 15 wt % of a water miscible solvent,
C. 2 to 15 wt % of at least one surfactant of formula (I),
C1. 5 to 15 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B 1. 5 to 15 wt % of a water immiscible solvent such as Solvesso and 5 to 15 wt % of a water miscible solvent,
C. 2 to 15 wt % of at least one surfactant of formula (II) wherein R¹ and R² are C₁₂-C₁₈ alkyl and n and m are a number from 6 to 8,
C1. 5 to 15 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 10 to 95 wt % of Methylbenzoate,
B 1. 0 to 40 wt % of further solvents,
C. 1 to 20 wt % of at least one surfactant of formula (II) wherein R¹ and R² are C₁₂-C₁₈ alkyl and n and m are a number from 6 to 8,
C1. 0.1 to 20 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B 1. 5 to 30 wt % of further solvents,
C. 2 to 15 wt % of at least one surfactant of formula (II) wherein R¹ and R² are C₁₂-C₁₈ alkyl and n and m are a number from 6 to 8,
C1. 0.1 to 20 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B 1. 5 to 30 wt % of aromatic hydrocarbons such as Solvesso and water miscible solvents,
C. 2 to 15 wt % of at least one surfactant of formula (II) wherein R¹ and R² are C₁₂-C₁₈ alkyl and n and m are a number from 6 to 8,
C1. 5 to 15 wt % of at least one anionic and/or nonionic surfactant different from surfactant C,
D. 0 to 10 wt % of further formulation auxiliaries.

In one embodiment, formulation according to the invention comprise
A. 0.1 to 10 wt % of Metyltetraprole,
B. 40 to 70 wt % of Methylbenzoate,
B 1. 5 to 15 wt % of a water immiscible solvent such as Solvesso and 5 to 15 wt % of a water miscible solvent,
C. 2 to 15 wt % of at least one surfactant of formula (II) wherein R¹ and R² are C₁₂-C₁₈ alkyl and n and m are a number from 6 to 8,
C1. 5 to 15 wt % of at least one anionic and/or nonionic surfactant different from surfactant C,
D. 0 to 10 wt % of further formulation auxiliaries.

In one embodiment, formulations of the invention comprise, in each case based on the formulation,
A. 0.1 to 60 wt % of one or more pesticide P comprising indiflin, mefentrifluconazol, fluxapyroxad, a strobilurin pesticide or mixtures thereof,
B. 40 to 70 wt % of benzoic acid ester,
B1 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising indiflin, mefentrifluconazol, fluxapyroxad, a strobilurin pesticide or mixtures thereof,
B. 40 to 70 wt % of benzyl benzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising indiflin, mefentrifluconazol, fluxapyroxad, a strobilurin pesticide or mixtures thereof,
B. 40 to 70 wt % of esters of benzoic acid with a glycol or diglycol, especially propylene glycol dibenzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising a strobilurin pesticide,
B. 40 to 70 wt % of benzoic acid ester,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising a strobilurin pesticide,
B. 40 to 70 wt % of benzyl benzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising a strobilurin pesticide,
B. 40 to 70 wt % of esters of benzoic acid with a glycol or diglycol, especially propylene glycol dibenzoate,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising metyltetraprole,
B. 40 to 70 wt % of benzoic acid ester,
B1. 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising metyltetraprole,
B. 40 to 70 wt % of benzyl benzoate,
B1 10 to 30 wt % of further solvents,
C. 1 to 30 wt % of at least one anionic and/or nonionic surfactant,
D. 1 to 10 wt % of further formulation auxiliaries.

In one embodiment, formulations of the invention comprise, in each case based on the formulation,
A. 0.1 to 60 wt % of one or more pesticide P comprising metyltetraprole,
B. 40 to 70 wt % of esters of benzoic acid with a glycol or diglycol, especially propylene glycol dibenzoate,
B1. 10 to 30 wt % of further solvents,
C. 1 to 30 wt % of at least one anionic and/or nonionic surfactant,
D. 1 to 10 wt % of further formulation auxiliaries.

Formulations of the invention are suitable for the purposes of treatment of plant propagation materials, particularly seeds. The formulations in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating the pesticide and formulations thereof, respectively, on to plant propagation material, especially seeds include dressing, coating, pelleting, dusting, soaking and in-furrow application methods of the propagation material. Preferably, the pesticide or the formulations thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha.

In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners) may be added to the active substances or the formulations comprising them as premix or, if appropriate not until immediately prior to use (tank mix). These agents can be admixed with the formulations according to the invention in a weight ratio of 1:100 to 100:1, preferably 1:10 to 10:1.

The concentration of the alkoxylate of the formula (I) in the ready-to-use preparation (e.g. the tank mix) is in most cases in the range of from 0.01 to 50 g/l, preferably 0.08 to 10 g/l and in particular 0.5 to 8 g/l.

The concentration of water in the ready-to-use preparation (e.g. the tank mix) is in most cases at least 60 wt %, preferably at least 75 wt %, and in particular at least 90 wt %.

The tank mix is usually an aqueous liquid, which is ready to be applied (e.g. by spraying) in the method of controlling phytopathogenic fungi and/or undesired plant growth and/or undesired insect or mite attack and/or for regulating the growth of plants.

The user applies the formulation according to the invention usually from a predosage device, a knapsack sprayer, a spray tank, a spray plane, a drone, an unmanned aerial vehicle or an irrigation system. Usually, the agrochemical formulation is made up with water, buffer, and/or further auxiliaries to the desired application concentration and the ready-to-use spray liquor or the agrochemical formulation according to the invention is thus obtained. Usually, 20 to 2000 liters, preferably 50 to 400 liters, of the ready-to-use spray liquor are applied per hectare of agricultural useful area.

According to one embodiment, individual components of the formulation according to the invention such as parts of a kit or parts of a binary or ternary mixture may be mixed by the user himself in a spray tank and further auxiliaries may be added, if appropriate.

In a further embodiment, either individual components of the formulation according to the invention or partially premixed components, e. g. components comprising the pesticide and the adjuvant, may be mixed by the user in a spray tank and further auxiliaries and additives may be added, if appropriate. In a further embodiment, either individual components of the formulation according to the invention or partially premixed components, e. g. components comprising the pesticide and/or the adjuvant can be applied jointly (e.g. after tank mix) or consecutively.

The present invention furthermore relates to a method of preparing the formulation according to the invention by bringing the adjuvant of the formula (I) and the pesticide into contact, e.g. by mixing. The contacting may be done between 5 to 95° C. Thus, a tank mix or an agrochemical formulation may be prepared.

The present invention furthermore relates to a non-therapeutic method of controlling phytopathogenic fungi and/or undesired plant growth and/or undesired insect or mite attack and/or for regulating the growth of plants, wherein the liquid formulations comprising according to any of claims 1 to 16 are allowed to act on the respective pests, their environment or the crop plants to be protected from the respective pest, on the soil and/or on undesired plants and/or on the crop plants and/or on their environment.

Examples of suitable crop plants are cereals, for example wheat, rye, barley, triticale, oats or rice; beet, for example sugar or fodder beet; pome fruit, stone fruit and soft fruit, for example apples, pears, plums, peaches, almonds, cherries, strawberries, raspberries, currants or gooseberries; legumes, for example beans, lentils, peas, lucerne or soybeans; oil crops, for example oilseed rape, mustard, olives, sunflowers, coconut, cacao, castor beans, oil palm, peanuts or soybeans; cucurbits, for example pumpkins/squash, cucumbers or melons; fiber crops, for example cotton, flax, hemp or jute; citrus fruit, for example oranges, lemons, grapefruit or tangerines; vegetable plants, for example spinach, lettuce, asparagus, cabbages, carrots, onions, tomatoes, potatoes, pumpkin/squash or capsicums; plants of the laurel family, for example avocados, cinnamon or camphor; energy crops and industrial feedstock crops, for example maize, soybeans, wheat, oilseed rape, sugar cane or oil palm; maize; tobacco; nuts; coffee; tea; bananas; wine (dessert grapes and grapes for vinification); hops; grass, for example turf; sweetleaf (Stevia rebaudania); rubber plants and forest plants, for example flowers, shrubs, deciduous trees and coniferous trees, and propagation material, for example seeds, and harvested produce of these plants.

The term crop plants also includes those plants which have been modified by breeding, mutagenesis or recombinant methods, including the biotechnological agricultural products which are on the market or in the process of being developed. Genetically modified plants are plants whose genetic material has been modified in a manner which does not occur under natural conditions by hybridizing, mutations or natural recombination (i.e. recombination of the genetic material). Here, one or more genes will, as a rule, be integrated into the genetic material of the plant in order to improve the plant's properties. Such recombinant modifications also comprise posttranslational modifications of proteins, oligo- or polypeptides, for example by means of glycosylation or binding polymers such as, for example, prenylated, acetylated or farnesylated residues or PEG residues.

The present invention also relates to seed (such as seeds or other plant propagation materials) comprising the formulation according to the invention. Plant propagation materials can be treated preventively with the formulation according to the invention at the point of or even before sowing or at the point of or even before transplanting. The formulations of the invention can be applied to the propagation materials, in particular seed, in undiluted form or, preferably, in diluted form. Here, the formulation in question can be diluted 2- to 10-fold, so that from 0.01 to 60% by weight, preferably from 0.1 to 40% by weight, of active substance is present in the formulations used for the seed dressing. The application may be effected before or during sowing. The treatment of plant propagation material, in particular the treatment of seed, is known to the skilled worker and carried out by dusting, coating, pelleting, dipping or soaking the plant propagation material, the treatment preferably being carried out by pelleting, coating and dusting or by in-furrow treatment so that, for example, untimely early germination of the seed is prevented. It is preferred to use suspensions for the treatment of seed. Usually, such formulations comprise from 1 to 800 g/l of active substance, from 1 to 200 g/l of surfactants, from 0 to 200 g/l of antifreeze agents, from 0 to 400 g/l of binders, from 0 to 200 g/l of colorants and solvent, preferably water.

The advantages of the invention are high stability of the formulation and of the spray mixture, little formation of precipitate and/or crystalline pesticide, easy applicability, good adhesion of the formulation on the surface of the treated plants, high biological activity, increased solubility of the pesticides in the formulation, increased uptake of the pesticides into the plant, or more rapid or enhanced activity of the pesticide (e.g. even at a low dose rate). Other advantages are the high biodegradability of the components; the low toxicity of the components, the low harmful effect against crop plants, i.e. low phytotoxic effects.

Formulations of the invention have a low odor, especially those comprising benzoic esters having a molecular weight of at least 200 g/mol.

The examples which follow illustrate the invention without imposing any limitation.

### EXAMPLES

### Used Materials

Surfactant A Calcium dodecylbenzolsulfonate, 60 wt % in ethyl hexanol
Surfactant B Castor oil, ethoxylated
Surfactant C tristyrylphenol, ethoxylated with 16 EO units
Surfactant D ethoxylated castor oil, POE 20
Adjuvant A as prepared below
Adjuvant B Alcohols, C11-14-iso-, C13-rich, ethoxylated propoxylated
Adjuvant C fatty Alcohol C₁₂-18, ethoxylated propoxylated
Adjuvant D 2-propyl heptyl, ethoxylated propoxylated
Adjuvant E 2-propyl heptyl, ethoxylated propoxylated
Solvent A water miscible solvent
Solvent B Solvesso 200 ND (aromatic hydrocarbon mixture)
Solvent C C8-C10 fatty acid dimethyl amide
Solvent D Methylbenzoate
Solvent E benzyl acetate
Solvent F benzoic acid benzyl ester
Solvent G C10 fatty acid dimethyl amide
Solvent H methyl oleate
Solvent J propylene glycol dibenzoate
Solvent K N-(n-butyl) pyrrolidone

### Preparation of Adjuvant A

0.33 mol of ethoxylated (7 EO units) C₁₂-C₁₈ fatty alcohol and diethyl carbonate (0.23 mol) were mixed with 0.59 g sodium methylate (30% in methanol) and heated to 80° C. while stirring. The temperature was increased to 140° C. and the resulting ethanol was distilled off. When no more ethanol was distilled off, a vacuum of 1 mbar was applied to remove further volatile components. Finally, the composition was cooled to room temperature and filtered. Adjuvant A was obtained as yellowish product.

### Examples 1 to 24

In examples 1 to 24, agrochemical formulations were prepared by mixing the components given in Table 1. In all cases clear solutions were obtained at room temperature.

To determine the storage stability of the formulations, 25 ml of each formulation were placed in vials having a volume of 40 ml and stored at 0° C. for four weeks, with seed crystals of Metyltetraprole being added after one week of storage. After four weeks, the presence and size of precipitate of Metyltetraprole was visually evaluated and rated from “−−” to “++”, “++” meaning that crystals have dissolved and a clear solutions was present and “−−” meaning that the crystals have grown significantly in size.

To determine how easy the handling and application of the formulations was (“2 L lab application test”, “Applicability”), the formulations obtained in examples 1 to 24 were diluted with CIPAC D standard water to obtain emulsions containing 0.5 wt % of the formulation in water having a temperature of 10° C. Two liters of the diluted emulsion so obtained were continuously pumped through a cascade of one 300 μm sieve and one 150 μm sieve at an initial flow rate that was set at 100 liters per hour. The circulated spray liquid was in total 5 times replaced with fresh formulation after 1, 2, 2.5 and 4 hours on the first day and upon start of the second day and after 1 hour on the second day. Overall duration of the test was 12 hours over two days (six hours per day). The application properties of the formulations were rated from “++” to “−−” based on the flow of the diluted emulsion through the sieves in the final filtration cycle and visual evaluation of the residue in the sieves. A rating of “−−” means that the sieves contained a high amount of residue and a slow flow of the diluted emulsion through the sieve, a rating of “++” means essentially unchanged flow of the diluted emulsion through the sieve and that almost no residue was collected in the sieves. For a handling rating of “+”, the flow at the end of the test had to be 90% or more of the initial flow rate (i.e. at least 90 l/h).

TABLE 1
Components and properties of examples 1 to 24, the
content of each component is given in grams;

| | 1 | 2 | 3 | 4 | 5 | 6 | 7 | 8 |
|---|---|---|---|---|---|---|---|---|
| Metyltetraprole | 60 | 60 | 60 | 60 | 60 | 60 | 60 | 60 |
| Surfactant A | 20 | 20 | 20 | 20 | 20 | 20 | 20 | 20 |
| Surfactant B | 15 | 20 | 20 | 20 | 20 | 20 | 20 | 20 |
| Surfactant C | 50 | 0 | 0 | 0 | 0 | 0 | 0 | 0 |
| Surfactant D | 0 | 0 | 0 | 0 | 0 | 0 | 0 | 0 |
| Adjuvant A | 0 | 0 | 0 | 0 | 0 | 0 | 0 | 0 |
| Adjuvant B | 0 | 25 | 0 | 0 | 0 | 0 | 0 | 25 |
| Adjuvant C | 0 | 75 | 0 | 30 | 0 | 50 | 75 | 75 |
| Solvent A | 75 | 75 | 75 | 75 | 75 | 75 | 75 | 75 |
| Solvent B | 80 | 80 | 80 | 80 | 80 | 80 | 80 | 80 |
| Solvent C | 0 | 0 | 0 | 0 | 0 | 0 | 0 | 0 |
| Solvent D | 0 | 0 | 0 | 0 | 0 | 0 | 0 | Ad 1 |
| | | | | | | | | liter 0 |
| Solvent E | Ad 1 | Ad 1 | Ad 1 | Ad 1 | Ad 1 | Ad 1 | Ad 1 | |
| | liter | liter | Liter | liter | liter | liter | liter | |
| Cold storage | 0 | −− | −− | −− | −− | −− | −− | ++ |
| (0° C., 4 weeks) | | | | | | | | |
| Applicability | 0*** | −*** | n.b. | n.b. | n.b. | n.b. | n.b. | −− |

| | 9 | 10 | 11 | 12 | 13 | 14 | 15 | 16 |
|---|---|---|---|---|---|---|---|---|
| Metyltetraprole | 60 | 60 | 60 | 60 | 60 | 60 | 60 | 60 |
| Surfactant A | 20 | 20 | 40 | 40 | 0 | 40 | 40 | 20 |
| Surfactant B | 20 | 20 | 40 | 40 | 0 | 40 | 40 | 20 |
| Surfactant C | 50 | 50 | 0 | 0 | 50 | 0 | 0 | 0 |
| Surfactant D | 0 | 0 | 0 | 0 | 25 | 0 | 0 | 0 |
| Adjuvant A | 0 | 0 | 0 | 0 | 0 | 0 | 0 | 0 |
| Adjuvant B | 25 | 0 | 37.5 | 25 | 25 | 25 | 25 | 0 |
| Adjuvant C | 75 | 75 | 75 | 75 | 75 | 75 | 75 | 100 |
| Solvent A | 75 | 75 | 75 | 75 | 75 | 0 | 75 | 75 |
| Solvent B | 30 | 80 | 30 | 80 | 50 | 80 | 100 | 80 |
| Solvent C | 0 | 0 | 0 | 0 | 0 | 0 | 0 | 75 |
| Solvent D | Ad 1 | Ad 1 | Ad 1 | Ad 1 | Ad 1 | Ad 1 | Ad 1 | Ad 1 |
| | liter | liter | liter | liter | liter | liter | liter | liter |
| Solvent E | 0 | 0 | 0 | 0 | 0 | 0 | 0 | 0 |
| Cold storage | −−* | + | −− | −−** | − | n.b. | −−* | n.b. |
| (0° C., 4 weeks) | | | | | | | | |
| Applicability | − | − | n.b. | n.b. | 0 | −− | 0 | −− |
| | 17 | 18 | 19 | 20 | 21 | 22 | 23 | 24 |
| Metyltetraprole | 60 | 60 | 60 | 60 | 60 | 60 | 60 | 60 |
| Surfactant A | 40 | 40 | 40 | 40 | 20 | 40 | 20 | 20 |
| Surfactant B | 40 | 40 | 40 | 40 | 15 | 40 | 15 | 15 |
| Surfactant C | 0 | 0 | 0 | 0 | 50 | 0 | 50 | 50 |
| Surfactant D | 0 | 0 | 0 | 0 | 0 | 0 | 0 | 0 |
| Adjuvant A | 0 | 0 | 0 | 0 | 0 | 0 | 0 | 100 |
| Adjuvant B | 25 | 25 | 50 | 50 | 50 | 0 | 50 | 50 |
| Adjuvant C | 100 | 100 | 100 | 100 | 75 | 150 | 75 | 0 |
| Solvent A | 75 | 75 | 75 | 75 | 0 | 75 | 75 | 75 |
| Solvent B | 100 | 100 | 100 | 100 | 100 | 100 | 80 | 100 |
| Solvent C | 0 | 0 | 0 | 0 | 0 | 0 | 75 | 0 |
| Solvent D | Ad 1 | Ad 1 | Ad 1 | Ad 1 | Ad 1 | Ad 1 | Ad 1 | Ad 1 |
| | liter | liter | liter | liter | liter | liter | liter | liter |
| Solvent E | 0 | 0 | 0 | 0 | 0 | 0 | 0 | 0 |
| Cold storage | −−* | −− | −− | −− | −−** | −− | n.b. | + |
| (−10° C., 4 | | | | | | | | |
| weeks) | | | | | | | | |
| Applicability | −− | −− | −− | 0 | −− | n.b. | 0 | + |

*determined at 5° C.;
**determined at −5° C.;
***Applicability determined with 0.17 wt % application rate;
n.b.: not determined.
***Applicability determined with 0.17 wt % content in the diluted emulsion instead of 0.5 wt %.

### Examples 25 to 37

In examples 25 to 37, agrochemical formulations were prepared by mixing the components given in Table 2. In all cases clear solution were obtained at room temperature.

To determine the storage stability of the formulations, 25 ml of each formulation were placed in vials having a volume of 40 ml and stored at 0° C. for four weeks, with seed crystals of Metyltetraprole being added after one week of storage. After four weeks, the presence and size of precipitate of Metyltetraprole was visually evaluated and rated from “−−” to “++”, “++” meaning that crystals have dissolved and a clear solution was present and “−−” meaning that the crystals have grown significantly in size.

To determine how easy the handling and application of the formulations was ((“2 L lab application test”, “Applicability”), the formulations obtained in examples 1 to 24 were diluted with CIPAC D standard water to obtain emulsions containing 0.5 wt % or 0.167 wt % of the formulation in water having a temperature of 10° C. Two liters of the diluted emulsion so obtained were continuously pumped through a cascade of one 300 μm sieve and one 150 μm sieve at an initial flow rate that was set at 100 liters per hour. The circulated spray liquid was in total 5 times replaced with fresh formulation after 1, 2, 2.5 and 4 hours on the first day and upon start of the second day and after 1 hour on the second day. Overall duration of the test was 12 hours over two days (six hours per day). The application properties of the formulations were rated from “++” to “−−” based on the flow of the diluted emulsion through the sieves in the final filtration cycle and visual evaluation of the residue in the sieves. A rating of “−−” means that the sieves contained a high amount of residue and a slow flow of the diluted emulsion through the sieve, a rating of “++” means essentially unchanged flow of the diluted emulsion through the sieve and that almost no residue was collected in the sieves. For a handling rating of “+”, the flow at the end of the test had to be 90% or more of the initial flow rate (i.e. at least 90 l/h).

In the “Tapered Cylinder Test”, 99 g of CIPAC D water were weighed into a clean tapered cylinder. 1 g of formulation is added, then the cylinder is stoppered. The spontaneity of the emulsion was assessed. For the present set of examples, the examples showed a partial self-emulsification in all cases (“pse”), meaning an emulsion with a small amount of residual unemulsified oil. After that, the cylinders were inverted 10 times for 180°. The upright, stoppered cylinder was then placed in a stand and left undisturbed for the readings of cream, sediment or free oil after the time given in the table below. The numbers reflect the amount of cream, sediment or oil. Unless specified otherwise in the table, the numbers given are the amount of cream in ml.

In the header, the storage period and storage temperature are given. In the left column, the time after completing the inversions is given.

TABLE 2
Components and properties of examples 25 to 37, the content of each component is given in grams.

| | 25 | 26 | 27 | 28 | 29 |
|---|---|---|---|---|---|
| metyltetraprol | 60 | 60 | 40 | 40 | 40 |
| mefentrifluconazol | | | | | |
| fluxapyroxad | | | 40 | 40 | 40 |
| Solvent F | 500 | 600 | 500 | 580 | 400 |
| Solvent A | 100 | 100 | 100 | 100 | 100 |
| Solvent G | 200 | 100 | 180 | 100 | 180 |
| Adjuvant D | 50 | 50 | 50 | 50 | 50 |
| Adjuvant C | 50 | 50 | 50 | 50 | 50 |
| Solvent H | | | | | 100 |
| Surfactant A | 20 | 20 | 20 | 20 | 20 |
| Surfactant B | 20 | 20 | 20 | 20 | 20 |
| Surfactant C | 50 | 50 | 50 | 50 | 50 |
| | Tapered cylinder test initial (ml) | | Tapered cylinder test initial (ml) | | |
| immediately | pse | pse | pse | pse | pse |
| 2 h | 0.40 | 0.40 | 0.30 | 0.50 | 0.30 |
| 24 h | 1.00 | 1.00 | 0.60 | 0.50 | 0.60 |
| | Tapered cylinder test 4 weeks −10° C. (ml) | | Tapered cylinder test 4 weeks −10° C. (ml) | | |
| immediately | pse | pse | pse | pse | pse |
| 2 h | 0.25 | 0.30 | 0.40 | 0.40 | 0.20 |
| 24 h | 1.00 | 1.25 | 0.70 | 1.25 | 0.50 |
| | appearance | | appearance | | |
| immediately | clear solution | clear solution | clear solution | clear solution | clear solution |
| 4Wochen −10° C. | clear solution | clear solution | clear solution | clear solution | clear solution |
| 4 Wochen 0° C. | clear solution | clear solution | clear solution | clear solution | clear solution |
| 4 Wochen +5° C. | clear solution | clear solution t | clear solution | clear solution | clear solution |
| 4 Wochen +20° C. | clear solution | clear solution | clear solution | clear solution | clear solution |
| | Applicability 0.5% ig | | Applicability 0.5% ig | | |
| | ++ | ++ | ++ | ++ | ++ |
| | Applicability 0.167% ig | | Applicability 0.167% ig | | |
| | ++ | ++ | ++ | ++ | + |

| | 30 | 31 | 32 | 33 | 34 |
|---|---|---|---|---|---|
| metyltetraprol | 30 | 30 | 30 | 30 | 40 |
| mefentrifluconazol | | | 50 | 50 | 50 |
| fluxapyroxad | 60 | 60 | | | |
| Solvent F | 400 | 470 | 480 | 380 | 470 |
| Solvent A | 100 | 100 | 100 | 100 | 100 |
| Solvent G | 270 | 200 | 200 | 200 | 200 |
| Adjuvant D | 50 | 50 | 50 | 50 | 50 |
| Adjuvant C | 50 | 50 | 50 | 50 | 50 |
| Solvent H | | | | 100 | |
| Surfactant A | 20 | 20 | 20 | 20 | 20 |
| Surfactant B | 20 | 20 | 20 | 20 | 20 |
| Surfactant C | 50 | 50 | 50 | 50 | 50 |
| | Tapered cylinder test initial (ml) | | | | |
| immediately | pse | pse | pse | pse | pse |
| 2 h | 0.30 | 0.30 | 0.30 | 0.10 | 0.35 |
| 24 h | 0.60 | 0.60 | 0.70 | 0.25 | 0.70 |
| | Tapered cylinder test 4 weeks −10° C. (ml) | | | | |
| immediately | pse | pse | pse | pse | pse |
| 2 h | 0.40 | 0.35 | 0.30 | 0.05 | 0.40 |
| 24 h | 0.75 | 0.75 | 0.80 | 0.35 | 0.55 |
| | Optical appearance | | | | |
| immediately | clear solution | clear solution | clear solution | clear solution | clear solution |
| 4Wochen −10° C. | clear solution | clear solution | clear solution | clear solution | clear solution |
| 4 Wochen 0° C. | clear solution | clear solution | clear solution | clear solution | clear solution |
| 4 Wochen +5° C. | clear solution | clear solution | clear solution | clear solution | clear solution |
| 4 Wochen +20° C. | clear solution | clear solution | clear solution | clear solution | clear solution |
| | Applicability 0.5% | | | | |
| | ++ | ++ | ++ | ++ | ++ |
| | | | | 10% bei 4. Bef. | |
| | | | | 25% in the end | |
| | Applicability 0.167% | | | | |
| | ++ | ++ | ++ | ++ | |

| | 35 | 36 | 37 |
|---|---|---|---|
| metyltetraprol | 40 | 30 | 26.6 |
| mefentrifluconazol | 50 | 75 | 60 |
| fluxapyroxad | | 50 | 40 |
| Solvent F | 470 | 420 | 420 |
| Solvent A | 100 | 85 | 85 |
| Solvent G | 200 | 200 | 200 |
| Adjuvant D | 50 | 50 | 50 |
| Adjuvant C | 50 | 50 | 50 |
| Solvent H | | | |
| Surfactant A | 20 | 20 | 20 |
| Surfactant B | 20 | 20 | 20 |
| Surfactant C | 50 | 50 | 50 |

Tapered cylinder test initial (ml)

| | | | |
|---|---|---|---|
| immediately | pse | pse | pse |
| 2 h | 0.45 | 0.35 | 0.30 |
| 24 h | 0.70 | 0.70 | 0.70 |

Tapered cylinder test 4 weeks −10° C. (ml)

| | | | |
|---|---|---|---|
| immediately | pse | pse | pse |
| 2 h | 0.35 | 0.40 | 0.40 |
| 24 h | 0.55 | 0.75 | 0.90 |

Optical appearance

| | | | |
|---|---|---|---|
| immediately | clear solution | clear solution | clear solution |
| 4Wochen −10° C. | clear solution | clear solution | clear solution |
| 4 Wochen 0° C. | clear solution | clear solution | clear solution |
| 4 Wochen +5° C. | clear solution | clear solution | clear solution |
| 4 Wochen +20° C. | clear solution | clear solution | clear solution |

Applicability 0.5%

| | | |
|---|---|---|
| ++ | ++ | ++ |

Applicability 0.167%

| | |
|---|---|
| ++ | ++ |

### Examples 38 to 47

In examples 38 to 47, agrochemical formulations were prepared by mixing the components given in Table 3. In all cases clear solution were obtained at room temperature.

To determine the storage stability of the formulations, 25 ml of each formulation were placed in vials having a volume of 40 ml and stored at 0° C. for four weeks, with seed crystals of Metyltetraprole being added after one week of storage. After four weeks, the presence and size of precipitate of Metyltetraprole was visually evaluated and rated from “−−” to “++”, “++” meaning that crystals have dissolved and a clear solution was present and “−−” meaning that the crystals have grown significantly in size.

To determine how easy the handling and application of the formulations was (“2 L lab application test”, “Applicability”), the formulations obtained in examples 1 to 24 were diluted with CIPAC D standard water to obtain emulsions containing 0.5 wt % or 0.167 wt % of the formulation in water having a temperature of 10° C. Two liters of the diluted emulsion so obtained were continuously pumped through a cascade of one 300 μm sieve and one 150 μm sieve at an initial flow rate that was set at 100 liters per hour. The circulated spray liquid was in total 5 times replaced with fresh formulation after 1, 2, 2.5 and 4 hours on the first day and upon start of the second day and after 1 hour on the second day. Overall duration of the test was 12 hours over two days (six hours per day). The application properties of the formulations were rated from “++” to “−−” based on the flow of the diluted emulsion through the sieves in the final filtration cycle and visual evaluation of the residue in the sieves. A rating of “−−” means that the sieves contained a high amount of residue and a slow flow of the diluted emulsion through the sieve, a rating of “++” means essentially unchanged flow of the diluted emulsion through the sieve and that almost no residue was collected in the sieves. For a handling rating of “+”, the flow at the end of the test had to be 90% or more of the initial flow rate (i.e. at least 90 l/h).

In the “Tapered Cylinder Test”, 99 g of CIPAC D water were weighed into a clean tapered cylinder. 1 g of formulation is added, then the cylinder is stoppered. The spontaneity of the emulsion was assessed. For the present set of examples, the examples showed a partial self-emulsification in all cases (“pse”), meaning an emulsion with a small amount of residual unemulsified oil. After that, the cylinders were inverted 10 times for 180°. The upright, stoppered cylinder was then placed in a stand and left undisturbed for the readings of cream, sediment or free oil after the time given in the table below. The numbers reflect the amount of cream, sediment or oil. Unless specified otherwise in the table, the numbers given are the amount of cream in ml.

In the header, the storage period and storage temperature are given. In the left column, the time after completing the inversions is given.

TABLE 3
Components and properties of examples 38 to 47,
the content of each component is given in grams.

| Example No | 38 | 39 | 40 | 41 | 42 | 43 |
|---|---|---|---|---|---|---|
| metyltetraprol | 40 | 30 | 30 | 30 | 30 | 40 |
| mefentrifluconazol | | | | 50 | 50 | 50 |
| Indiflin | | | | | | |
| fluxapyroxad | 40 | 60 | 60 | | | |
| Solvent J | 500 | 400 | 470 | 480 | 480 | 470 |
| Solvent A | 100 | 100 | | 100 | | 100 |
| Solvent K | | | 100 | | 100 | |
| Solvent C | | | | | | |
| Solvent G | 180 | 270 | 200 | 200 | 200 | 200 |
| Adjuvant E | 50 | 50 | 50 | 50 | 50 | 50 |
| Adjuvant C | 50 | 50 | 50 | 50 | 50 | 50 |
| Surfactant A | 20 | 20 | 20 | 20 | 20 | 20 |
| Surfactant B | 20 | 20 | 20 | 20 | 20 | 20 |
| Surfactant C | 50 | 50 | 50 | 50 | 50 | 50 |

| | |
|---|---|
| Tapered cylinder test initial (ml) | Tapered cylinder test initial (ml) |

| | | | | | | |
|---|---|---|---|---|---|---|
| immediately | pse | pse | pse | pse | pse | pse |
| 2 h | 0.35 | 0.25 | 0.10 | 0.30 | 0.10 | 0.30 |
| 24 h | 0.70 | 0.50 | 0.25 | 0.50 | 0.25 | 0.50 |

| | |
|---|---|
| Tapered cylinder test 4 | Tapered cylinder test 4 |
| weeks −10° C. (ml) | weeks −10° C. (ml) |

| | | | | | | |
|---|---|---|---|---|---|---|
| immediately | pse | pse | pse | pse | pse | pse |
| 2 h | 0.25 | 0.25 | 0.15 | 0.25 | 0.1(Oil) | 0.25 |
| 24 h | 0.50 | 0.50 | 0.25 | 0.50 | 0.25(Oil) | 0.50 |
| immediately | clear | clear | clear | clear | clear | clear |
| | solution | solution | solution | solution | solution | solution |
| 4 weeks −10° C. | clear | clear | clear | clear | clear | clear |
| | solution | solution | solution | solution | solution | solution |
| 4 weeks 0° C. | clear | clear | clear | clear | clear | clear |
| | solution | solution | solution | solution | solution | solution |
| 4 weeks +5° C. | clear | clear | clear | clear | clear | clear |
| | solution | solution | solution | solution | solution | solution |
| 4 weeks +20° C. | clear | clear | clear | clear | clear | clear |
| | solution | solution | solution | solution | solution | solution |

| | |
|---|---|
| Applicability 0.5% ig | Applicability 0.5% ig |

| | | | | | |
|---|---|---|---|---|---|
| + | + | + | + | + | + |

| | |
|---|---|
| Applicability 0.167% ig | Applicability 0.167% ig |

| | | | | | |
|---|---|---|---|---|---|
| ++ | ++ | ++ | ++ | ++ | ++ |

| Example No | 44 | 45 | 46 | 47 |
|---|---|---|---|---|
| metyltetraprol | 30 | 30 | | |
| mefentrifluconazol | 75 | 75 | 100 | 100 |
| Indiflin | | | 40 | 40 |
| fluxapyroxad | 50 | 50 | | |
| Solvent J | 420 | 420 | 170 | 305 |
| Solvent A | 85 | | 85 | |
| Solvent K | | 85 | | 90 |
| Solvent C | | | | |
| Solvent G | 200 | 200 | 440 | 300 |
| Adjuvant E | 50 | 50 | 40 | 40 |
| Adjuvant C | 50 | 50 | 40 | 40 |
| Surfactant A | 20 | 20 | 25 | 25 |
| Surfactant B | 20 | 20 | 20 | 20 |
| Surfactant C | 50 | 50 | 40 | 40 |
| | Tapered cylinder test initial (ml) | | Tapered cylinder test initial (ml) | |
| immediately | pse | pse | pse | pse |
| 2 h | 0.25 | <0.05(oil) | Fully emulsified | 0.1(Oil) |
| 24 h | 0.50 | 0.15(oil) | 0.15(Oil) | 0.15(Oil) |
| | Tapered cylinder test | | Tapered cylinder test 4 | |
| | 4 weeks −10° C. (ml) | | weeks −10° C. (ml) | |
| immediately | pse | pse | pse | pse |
| 2 h | 0.30 | 0.1(Oil) | 0 | 0.15(Oil) |
| 24 h | 0.55 | 0.15(Oil) | 0.1(Oil) | 0.25(Oil) |
| | Optical appearance | | Optical appearance | |
| immediately | clear solution | clear solution | clear solution | clear solution |
| 4 weeks −10° C. | minimal | minimal | minimal | minimal |
| | acceptable | acceptable | acceptable | acceptable |
| | crystal growth | crystal growth | crystal growth | crystal growth |
| 4 weeks 0° C. | clear solution | clear solution | clear solution | clear solution |
| 4 weeks +5° C. | clear solution | clear solution | clear solution | clear solution |
| 4 weeks +20° C. | clear solution | clear solution | clear solution | clear solution |
| | Applicability 0.5% ig | | Applicability 0.5% ig | |
| | ++ | ++ | ++ | ++ |
| | Applicability 0.167% ig | | Applicability 0.167% ig | |
| | ++ | ++ | ++ | ++ |

1. A liquid formulation comprising
a) one or more pesticide P,
b) a solvent system S comprising an ester of benzoic acid,
c) optionally at least one anionic and/or nonionic surfactant;
d) optionally further formulation auxiliaries;
wherein said one or more pesticide P is completely dissolved in solvent system S at 20° C.

2. The formulation according to claim 1, wherein said ester of benzoic acid is selected from esters with monools or diols.

3. The formulation according to claim 1, wherein said ester of benzoic acid is an alkyl benzoate.

4. The formulation according to claim 1, wherein said ester of benzoic acid is an ester with a glycol or diglycol.

5. The formulation according to claim 1, wherein said ester of benzoic acid is a diester with a glycol or diglycol comprising two benzoic acid moieties.

6. The formulation according to claim 1, wherein said ester of benzoic acid is a diester comprising two benzoic acid moieties esterified with a diol selected from ethylene glycol, diethylene glycol, propylene glycol or dipropylene glycol.

7. The formulation according to claim 1, wherein solvent system S comprises at least one further solvent.

8. The formulation according to claim 1, wherein solvent system S comprises at least one further solvent selected from N-alkyl pyrrolidone (especially N-methyl pyrrolidone, N-(n-butyl) pyrrolidone, N-(t-butyl) pyrrolidone or N-(sek-butyl) pyrrolidone), dibutyl adipate, dimethyl adipate, dimethylsulfoxide, N,N-dialkyl lactamide (especially N,N-dimethyllactamide), N,N-dialkyl amide (especially N,N-dimethyl octanoic acid amide, N,N-dimethyl decanoic acid amide, N,N-dimethyl capric amide, N,N-dimethyl caprylic amide), propylene carbonate, gamma butyrolactone and/or 1,3 dimethyl-2-imidazolidinone.

9. The formulation according to claim 1, wherein solvent system S comprises at least one aromatic hydrocarbon.

10. The formulation according to claim 1, wherein said one or more pesticide P is water insoluble.

11. The formulation according to claim 1, wherein said one or more pesticide P is selected from fungicides, insecticides, and/or herbicides.

12. The formulation according to claim 1, wherein said one or more pesticide P is metyltetraprole, mefentrifluconazole, fluxapyroxad, Inpyrfluxam, Kresoximmethyl, Pyraclostrobin, Fluopyram, saflufenacil, broflanilide, dimpropyridaz, fenmezoditiaz, Cinnamaldehyde, Prothioconazole, Trifloxystrobin, Fluxapyroxad, Sprioxamin, afidopyropen, alpha-cypermethrin, fipronil, cyflumetofen, boscalid, epoxiconazole, metconazole, metrafenone, prothioconazole, bentazone, dimethenamide, tembotrione, trifludimoxazin, indiflin, Mefenpyr-Diethyl or mixtures thereof.

13. The formulation according to claim 1, comprising
a) 0.1 to 60 wt % of one or more pesticide P,
b) 5 to 75 wt % of a benzoic acid ester,
b1) 10 to 40 wt % of further solvents,
c) 1 to 30 wt % of at least one anionic and/or nonionic surfactant,
d) 0 to 20 wt % of further formulation auxiliaries.

14. The formulation according to claim 1 wherein pesticide P is indiflin, mefentrifluconazole, fluxapyroxad, a strobilurin pesticide or mixtures thereof and wherein solvent system S comprises benzyl benzoate or propylene glycol dibenzoate or mixtures thereof.

15. The formulation according to claim 1 wherein pesticide P a strobilurin pesticide and wherein solvent system S comprises benzyl benzoate or propylene glycol dibenzoate or mixtures thereof.

16. A method of controlling phytopathogenic fungi and/or undesired plant growth and/or undesired insect or mite attack and/or for regulating the growth of plants, comprising allowing the liquid formulation according to claim 1 to act on pests, their environment or crop plants to be protected from the pests, on soil and/or on undesired plants and/or on crop plants and/or on their environment.

17. A seed comprising the liquid formulation as defined in claim 1.

18. The formulation according to claim 1, further comprising at least one anionic and/or nonionic surfactant.

19. The formulation according to claim 1, further comprising further formulation auxiliaries.

20. The formulation according to claim 3, the alkyl benzoate is methyl benzoate or benzyl benzoate.
